(19) United States
(12) Patent Application Publication
(10) Pub. No.: US 2026/0241433 A1
(43) Pub. Date: Aug. 20, 2026

(54) COATED STEEL, HOT STAMPING PARTS FORMED THEREFROM, AND HOT STAMPING METHOD

(71) Applicant: MAGNA INTERNATIONAL INC., Aurora (CA)

(72) Inventors: Jason BOETTGER, Brampton (CA); Cyrus YAU, Aurora (CA); Kyle DAUN, Waterloo (CA); Rodney D. L. SMITH, Waterloo (CA); Jixi ZHANG, Waterloo (CA)

(21) Appl. No.: 19/162,217

(22) PCT Filed: Mar. 6, 2024
(86) PCT No.: PCT/CA2024/050273

§ 371 Date: Sep. 4, 2025

Related U.S. Application Data
(60) Provisional application No. 63/450,394, filed on Mar. 7, 2023.

(51) Int. Cl. B21D 22/02; B32B 15/01; C22C 21/02

(52) U.S. Cl. CPC B21D 22/022; B32B 15/012; C22C 21/02

(57) ABSTRACT

A method of manufacturing a steel part, for example a part designed for use in a vehicle, is provided. The method includes applying an Al—Si coating to a blank formed of steel. The method further includes applying an iron-based coating to the Al—Si coating. The coated blank is then heated in a roller hearth furnace. During the heating step, the blank is conveyed along a plurality of ceramic rollers from an entrance to an exit of the furnace. The heating step typically includes heating the coated blank to a temperature ranging from 840° C. to 950° C. so that the iron from the steel blank and iron from the iron-based coating diffuses into the Al—Si coating and forms a layer of intermetallic compounds. The method then includes stamping the coated blank while the blank is at an elevated temperature to form the part.

### CROSS-REFERENCE TO RELATED APPLICATIONS

This PCT International Patent Application claims the benefit of and priority to U.S. Provisional Patent Application Ser. No. 63/450,394, filed Mar. 7, 2023, titled “Coated Steel, Hot Stamping Parts Formed Therefrom, And Hot Stamping Method,” the entire disclosure of which is hereby incorporated by reference in its entirety.

### BACKGROUND OF THE INVENTION

### 1. Field of the Invention

The present invention relates to a coated blank formed of steel, a method of manufacturing the coated steel blank, a part formed from the coated steel blank, and a method of manufacturing the part by hot stamping the coated steel blank.

### 2. Related Art

This section provides background information related to the present disclosure, which is not necessarily prior art.

Ultra-high strength parts formed of steel are often desired for use in vehicles. The ultra-high strength steel parts are typically formed from blanks of steel alloy. The method of manufacturing the part can include hot stamping the blank to achieve a desired shape. The hot stamping process typically includes heating the blank in a furnace to a temperature ranging from 880 to 950° C., and then transferring the heated blank to a die of a stamping press. The hot stamping process further includes forming and quenching the blank in the die to form the part.

The heating step of the hot stamping process often includes heating the blanks in a roller hearth furnace. The roller hearth furnace includes rollers, for example, rollers formed of ceramic, which convey the blanks from an entrance of the furnace to an exit of the furnace while the blanks are heating. Oftentimes, the steel blanks are coated with a material formed of aluminum and silicon, referred to as an Al—Si coating. The Al—Si coating is typically used to prevent oxidation and decarburization of the blanks in the furnace. During the heating process, the Al—Si coating reacts with iron from the substrate steel to form an intermetallic layer that provides corrosion protection. However, at least a portion of the Al—Si coating undergoes an intermediate transformation to a liquid phase during the heating process, and it has been found that the liquid can transfer onto the rollers of the roller hearth furnace, which can cause the rollers to break and require a costly repair. Thus, a technique which avoids or reduces the need for this costly repair is desired.

### SUMMARY

This section provides a general summary of the disclosure and is not to be interpreted as a complete and comprehensive listing of all of the objects, aspects, features and advantages associated with the present disclosure.

One aspect of the subject disclosure provides a blank formed of steel which is coated with a material formed of aluminum and silicon (Al—Si coating). The blank further includes a coating formed of an iron-based material (iron-based coating) disposed on the Al—Si coating.

Another aspect of the disclosure includes a method of manufacturing a blank formed of steel. The method includes applying an Al—Si coating to the steel, and then applying an iron-based coating to the Al—Si coating.

Another aspect of the disclosure provides a part formed of steel. The part includes an Al—Si coating disposed on the steel and an iron-based coating disposed on the Al—Si coating. The finished part typically includes an intermetallic layer formed from the Al—Si coating, the iron-based coating, and the iron from the steel.

Yet another aspect of the disclosure provides a method of manufacturing a part formed of steel. The method includes hot stamping a blank formed of the steel, wherein the blank includes an Al—Si coating disposed on the steel and an iron-based coating disposed on the Al—Si coating.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and are not intended to limit the scope of the present disclosure. The inventive concepts associated with the present disclosure will be more readily understood by reference to the following description in combination with the accompanying drawings wherein:

FIG. 1 illustrates a hot stamping process including a roller hearth furnace for manufacturing parts from steel blanks according to an example embodiment;

FIG. 2 includes examples of damaged ceramic rollers of a roller hearth furnace;

FIG. 3 illustrates a heating step of a hot stamping process according to an example embodiment and comparative embodiment; and FIG. 4 is a part, specifically a B-pillar, formed from a hot stamping process according to an example embodiment.

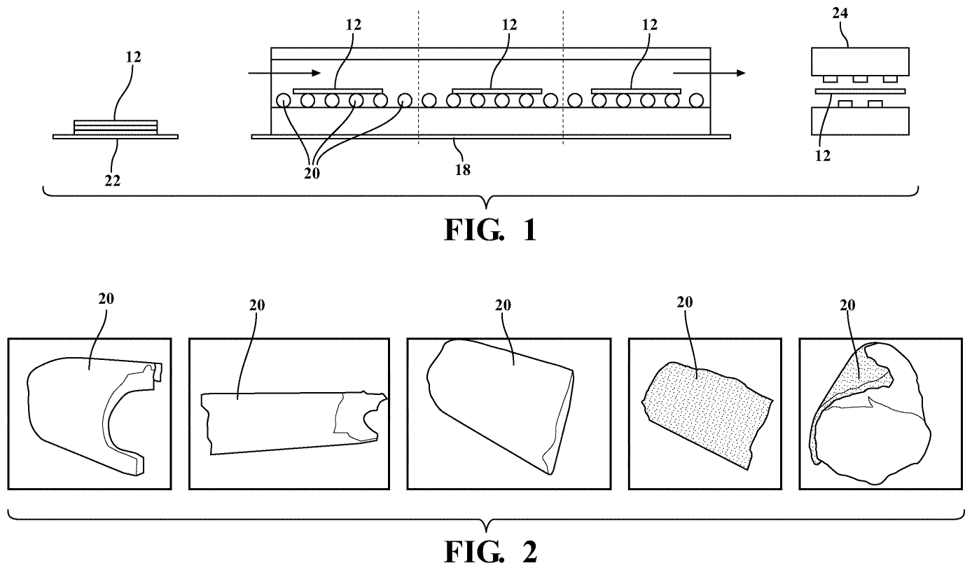

### DETAILED DESCRIPTION OF THE EXAMPLE EMBODIMENTS

Example embodiments will now be described more fully with reference to the accompanying drawings. However, the example embodiments are only provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

One aspect of the subject disclosure provides a method of manufacturing a part 10 for a vehicle, and specifically an ultra-high strength steel part 10. The part 10 can be designed for use as a body structure of a vehicle, for example an A-pillar, A-pillar reinforcement, side member, B-pillar, B-pillar reinforcement, hinge pillar, roof rail, header, roof bow, door ring, double door ring, front rail, rear rail, side reinforcement, rocker rail, rocker panel, firewall upper, firewall lower, firewall reinforcement, tunnel, and tunnel reinforcement. The part 10 can also be designed for use in a battery electric vehicles (BEV) or electric vehicles (EV), for example a side member of a battery tray, cross member of a battery tray, reinforcement of a battery tray, corner reinforcement, battery tray cover, and battery tray cover reinforcement.

The method begins by manufacturing or obtaining a blank 12 formed of steel, such as 22MnB5 steel or another steel alloy. The blank 12 is in the form of a sheet and typically has a thickness ranging from 0.5 to 3 millimeters.

The method next includes coating the blank 12 with a material formed from aluminum (Al) and silicon (Si), referred to as an Al—Si coating 14. More specifically, the Al—Si coating 14 is primarily a heterogeneous mixture of elemental aluminum and elemental silicon. The Al—Si coating 14 typically includes the aluminum in an amount of 85 to 95 wt. % and the silicon in an amount of 5 to 15 wt. %, for example 90 wt. % aluminum and 10 wt. % silicon, based on the total weight of the Al—Si coating 14. The Al—Si coating 14 typically has a thickness ranging from 1 to 100 micrometers, or 15 to 30 micrometers.

The method next includes applying a coating formed of an iron-based material, referred to as an iron-based coating 16, to the Al—Si coating 14. The iron-based coating 16 is preferably rich in iron and can be formed entirely of iron or can be formed of an iron-containing compound, such as Fe₂O₃. The iron-based coating 16 typically includes at least 90 wt. % iron, based on the total weight of the iron-based coating 16. The iron-based coating 16 typically has a thickness ranging from 0.1 to 300 millimeters.

The method next includes hot stamping the coated blank 12. This step includes heating the coated blank 12 in a furnace, such as a roller hearth furnace 18. In the roller hearth furnace 18, the blank 12 is conveyed along rollers 20 formed of ceramic from an entrance of the furnace 18 to the exit of the furnace 18. The blank 12 is typically heated to a temperature ranging from 840° C. to 950° C. The heating time typically ranges from 5 to 8 minutes.

During the heating step, iron from the steel blank 12 typically diffuses into the Al—Si coating 14 and forms a layer of intermetallic compounds 26. The intermetallic layer 26 can include Al₂FeSi, Al₃FeSi₂, Al₇Fe₂Si, Al_{4.5}FeSi, Al₃Fe, and Al₅Fe₂.

Also, during the heating step, the Al—Si coating 14, when used without the iron-based coating 16, typically melts into a semi-liquid state and transfers onto the ceramic rollers 20 of the furnace 18. However, when the iron-based coating 16 is applied to the Al—Si coating 14, iron from the iron-based coating 16 diffuses into the Ai-Si coating 14 and prevents the transfer of the Al—Si coating 14 onto the rollers 20.

More specifically, during the heating step, the iron from the iron-based coating 16 diffuses into the Al—Si coating 14 and contributes to the intermetallic layer 26. The presence of the iron-based coating 16 reduces the amount of time that the Al—Si coating 14 spends in the semi-liquid state, during which there is a high risk of roller contamination, which occurs before complete iron diffusion and re-solidification of the Al—Si coating 14. The intermetallic layer 26 can include Al₂FeSi, Al₃FeSi₂, Al₇Fe₂Si, Al_{4.5}FeSi, Al₃Fe, and Al₅Fe₂.

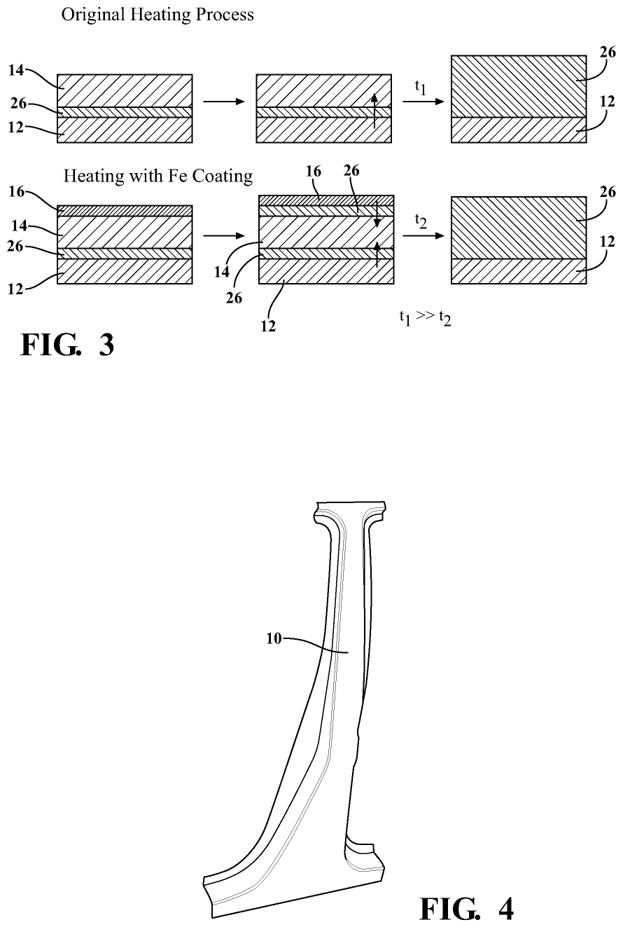

The iron-based coating 16 also increases the absorptive properties of the blank 12 and improves overall heating rate. Thus, the blank 12 including the iron-based coating 16 applied to the Al—Si coating 14 may require less time to reach the temperature needed for hot stamping, compared to blanks including the Al—Si coating without the iron-based coating. FIG. 3 illustrates the heating step according to an example embodiment, wherein the blank 12 includes the Al—Si coating 14 and the iron-based coating 16 as well as a comparative embodiment, wherein the blank includes only the Al—Si coating. As shown in FIG. 3, at the end of the heating process, the blank 12 includes the intermetallic layer 26 on the steel.

After the heating step, the hot stamping process includes transferring the heated and coated blank 12 to the die of the hot stamping press 24. The coated blank 12 is typically at a temperature ranging from 500° C. to 930° C. when the forming process begins. The coated blank 12 is then shaped and quenched in the die of the hot stamping press 24 to form the part 10. During this step, the blank 12 can be formed to a shape desired for use in a vehicle. An example of the hot formed part 10 is shown in FIG. 4. In this example, the hot formed part 10 is a B-pillar.

It should be appreciated that the foregoing description of the embodiments has been provided for purposes of illustration. In other words, the subject disclosure it is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varies in many ways. Such variations are not to be regarded as a departure from the disclosure, and all such modifications are intended to be included within the scope of disclosure.

1. A blank, comprising:
a sheet of steel;
an Al—Si coating disposed on the sheet of steel; and
an iron-based coating disposed on the Al—Si coating.

2. The blank according to claim 1, wherein the steel is 22MnB5 steel.

3. The blank according to claim 1, wherein the blank is formed of 22MnB5 steel and has a thickness ranging from 0.5 to 3 millimeters;
the Al—Si coating is a heterogeneous mixture of elemental aluminum and elemental silicon;
the Al—Si coating includes the aluminum in an amount of 85 to 95 wt. % and the silicon in an amount of 5 to 15 wt. %, based on the total weight of the Al—Si coating;
the Al—Si coating has a thickness ranging from 15 to 30 micrometers;
the iron-based coating is formed entirely of iron or Fe₂O₃;
the iron-based coating includes at least 90 wt. % iron, based on the total weight of the iron-based coating; and
the iron-based coating has a thickness ranging from 0.1 to 300 millimeters.

4. A method of manufacturing the blank according to claim 1, comprising the steps of:
applying the Al—Si coating to the sheet of steel, and
applying the iron-based coating to the Al—Si coating.

5. The method according to claim 4, wherein the heating step includes heating the coated blank in a roller hearth furnace.

6. The method according to claim 5, wherein the heating step includes conveying the coated blank along rollers formed of ceramic from an entrance of the roller hearth furnace to an exit of the roller hearth furnace.

7. A part, comprising:
a sheet of steel; and
an intermetallic layer formed from an Al—Si coating, an iron-based coating, and iron from the sheet of steel.

8. The part according to claim 7, wherein the intermetallic layer includes intermetallic compounds, and the intermetallic compounds include at least one of Al₂FeSi, Al₃FeSi₂, Al₇Fe₂Si, Al_{4.5}FeSi, Al₃Fe, and Al₅Fe₂.

9. The part according to claim 7, wherein the part is an A-pillar, A-pillar reinforcement, side member, B-pillar, B-pillar reinforcement, hinge pillar, roof rail, header, roof bow, door ring, double door ring, front rail, rear rail, side reinforcement, rocker rail, rocker panel, firewall upper, firewall lower, firewall reinforcement, tunnel, or tunnel reinforcement.

10. The part according to claim 7, wherein the part is a side member of a battery tray, cross member of a battery tray, reinforcement of a battery tray, corner reinforcement, battery tray cover, or battery tray cover reinforcement.

11. The part according to claim 7, wherein the part is a B-pillar.

12. A method of manufacturing a part, comprising:
applying an Al—Si coating to a blank formed of steel,
applying an iron-based coating to the Al—Si coating,
heating the coated blank, and
forming the coated blank after heating the coated blank.

13. The method according to claim 12, wherein the heating step includes heating the coated blank in a roller hearth furnace.

14. The method according to claim 12, wherein the heating step includes conveying the coated blank along rollers formed of ceramic from an entrance of the roller hearth furnace to an exit of the roller hearth furnace.

15. The method according to claim 12, wherein the blank is formed of 22MnB5 steel;
the blank has a thickness ranging from 0.5 to 3 millimeters;
the Al—Si coating is a heterogeneous mixture of elemental aluminum and elemental silicon;
the Al—Si coating includes the aluminum in an amount of 85 to 95 wt. % and the silicon in an amount of 5 to 15 wt. %, based on the total weight of the Al—Si coating;
the Al—Si coating has a thickness ranging from 15 to 30 micrometers;
the iron-based coating is formed entirely of iron or Fe₂O₃;
the iron-based coating includes at least 90 wt. % iron, based on the total weight of the iron-based coating;
the iron-based coating has a thickness ranging from 0.1 to 300 millimeters;
the step of heating the coated blank includes heating the coated blank in a roller hearth furnace;
the step of heating the coated blank in the roller hearth furnace includes conveying the coated blank along rollers formed of ceramic from an entrance of the furnace to an exit of the furnace;
the step of heating the coated blank includes heating the coated blank to a temperature ranging from 840° C. to 950° C. for 5 to 8 minutes;
wherein during the heating step, the iron from the iron-based coating diffuses into the Ai—Si coating and prevents the transfer of the Al—Si coating onto the rollers;
wherein during the heating step a layer of intermetallic compounds is formed in the blank, and the intermetallic compounds include at least one of Al₂FeSi, Al₃FeSi₂, Al₇Fe₂Si, Al_{4.5}FeSi, Al₃Fe, and Al₅Fe₂;
the forming step includes hot stamping;
the hot stamping step includes transferring the heated and coated blank to a die of a hot stamping press;
the hot stamping step includes stamping the coated blank while the coated blank is at a temperature ranging from 500° C. to 930° C.; and
the hot stamping step including quenching the blank in the die after the stamping step.

16. The blank according to claim 1, wherein the Al—Si coating includes the aluminum in an amount of 85 to 95 wt. % and the silicon in an amount of 5 to 15 wt. %, based on the total weight of the Al—Si coating; and the iron-based coating includes at least 90 wt. % iron, based on the total weight of the iron-based coating.

17. The blank according to claim 1, wherein the Al—Si coating is a heterogeneous mixture of elemental aluminum and elemental silicon; and the iron-based coating is formed entirely of iron or Fe₂O₃.

18. The method according to claim 12, wherein the Al—Si coating applied to the blank includes the aluminum in an amount of 85 to 95 wt. % and the silicon in an amount of 5 to 15 wt %, based on the total weight of the Al—Si coating; and the iron-based coating applied to the Al—Si coating includes at least 90 wt. % iron, based on the total weight of the iron-based coating.

19. The method according to claim 12, wherein the Al—Si coating is a heterogeneous mixture of elemental aluminum and elemental silicon; and the iron-based coating is formed entirely of iron or Fe₂O₃.

20. The method according to claim 12, wherein during the heating step a layer of intermetallic compounds is formed in the blank, and the intermetallic compounds include at least one of Al₂FeSi, Al₃FeSi₂, Al₇Fe₂Si, Al_{4.5}FeSi, Al₃Fe, and Al₅Fe₂.
